(19) United States
(12) Patent Application Publication
(10) Pub. No.: US 2018/0025374 A1
(43) Pub. Date: Jan. 25, 2018

(54) UNIFIED INCENTIVE FRAMEWORK FOR TASK-ORIENTED SERVICES

(71) Applicant: XEROX CORPORATION, Norwalk, CT (US)

(72) Inventors: Rahul Ghosh, Bangalore (IN); Soumi Chattopadhyay, West Bengal (IN); Ansuman Banerjee, West Bengal (IN); Koustuv Dasgupta, Bangalore (IN); Preethy Varma, Cochin (IN)

(21) Appl. No.: 15/215,634

(22) Filed: Jul. 21, 2016

(51) Int. Cl. G06Q 30/02; G06Q 10/06

(52) U.S. Cl. CPC G06Q 30/0208; G06Q 10/063114; G06Q 10/06393

(57) ABSTRACT

Embodiments of a system and a method for design and implementation of an employee incentive scheme for one or more tasks are disclosed. The system includes a data input module and a unified incentive module. The data input module on a computer with a processor and a memory being configured to: receive a task for a plurality of employees from the user device; and identify whether or not a task is associated with a predetermined baseline. The task is identified as a routine task if associated with the predetermined baseline, else the task is identified as a special task. The unified incentive module on the computer is configured to compute a task incentive for at least one of the routine task and the special task associated with an employee among multiple employees.

### TECHNICAL FIELD

The presently disclosed embodiments relate to incentive management systems, and more particularly, systems and methods to implement a unified incentive framework for task-oriented services.

### BACKGROUND

Organizations often motivate their employees to deliver high performance while ensuring organizational objectives being met. Employees can be motivated through incentives (e.g., cash, stocks, compensatory time-off, etc.) in addition to several other human resource management (HRM) tools such as trainings, challenging projects, appreciations, and so on. These incentives are typically calculated for various routine tasks based on available budget and the effort invested by the employees. Often, tasks include a set of routine tasks and special/exploratory tasks. The routine tasks are well-characterized tasks for which the organization has predefined baselines (e.g., completion timelines) and assignment policies. On the other hand, the special/exploratory tasks fulfill ad-hoc business requirements for which the associated baselines and allocation criteria are unknown.

Conventional incentive designs provide approaches that primarily focus on the routine tasks and their allocation. Often these traditional designs are tweaked based on preset, user-customized or randomly selected business objectives to calculate incentives for the special tasks. However, such existing designs are unable to fairly calculate and distribute the special task incentives among the employees based on their invested effort. Hence, high performers remain under-incentivized while low performers are not motivated to improve their performance and enhance service delivery. As a result, the organization may fail to meet business/organizational objectives or suffer from an undesirable employee attrition rate.

Therefore, there exists a need for a unified incentive design/framework that fairly calculates and distributes incentives for the routine tasks as well as the special tasks while ensuring a positive competition between employees and business/organizational objectives being met.

### SUMMARY

One exemplary embodiment of the present disclosure includes a computer implemented method for design and implementation of an employee incentive scheme for one or more tasks. The method comprises receiving, using a data input module on a computer with a processor and a memory, a task for a plurality of employees from a user device; identifying, using the data input module, whether or not the task is associated with a predetermined baseline, wherein the task being identified as a routine task if associated with the predetermined baseline, else the task being identified as a special task; and computing, using a unified incentive module on the computer, a task incentive for at least one of the routine task and the special task associated with an employee among the plurality of employees.

Another exemplary embodiment of the present disclosure includes a system for design and implementation of an employee incentive scheme for one or more tasks, the system being in communication with a user device. The system includes a data input module and a unified incentive module. The data input module on a computer with a processor and a memory being configured to: receive a task for a plurality of employees from the user device; and identify whether or not the task is associated with a predetermined baseline, wherein the task being identified as a routine task if associated with the predetermined baseline, else the task being identified as a special task. The unified incentive module on the computer is configured to compute a task incentive for at least one of the routine task and the special task associated with an employee among the plurality of employees.

Yet another exemplary embodiment of the present disclosure includes a non-transitory computer-readable medium comprising computer-executable instructions for design and implementation of an employee incentive scheme for one or more tasks, the non-transitory computer-readable medium comprising instructions for: receiving a task for a plurality of employees from a user device; identifying whether or not the task is associated with a predetermined baseline, wherein the task being identified as a routine task if associated with the predetermined baseline, else the task being identified as a special task; and computing a task incentive for at least one of the routine task and the special task associated with an employee among the plurality of employees.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIGS. 1-5 are schematics of network environments including an exemplary unified incentive device, according to an embodiment of the present disclosure.

FIG. 6 is a schematic that illustrates the unified incentive device of FIG. 1, according to an embodiment of the present disclosure.

FIG. 7 is an exemplary method for implementing a routine-task incentive computation (RTIC) module of the unified incentive device of FIG. 1, according to an embodiment of the present disclosure.

FIG. 8 is an exemplary method for implementing a special-task incentive computation (STIC) module in communication with other modules of the unified incentive device of FIG. 1, according to an embodiment of the present disclosure.

FIG. 9 is an exemplary graph that illustrates normalized key performance indicator (KPI) values of a rank-wise sorted employees, where the normalized KPI values are part of a dataset analyzed by the unified incentive device of FIG. 1, according to an embodiment of the preset disclosure.

FIG. 10 is a table that illustrates a comparison between a conventional incentive computation scheme and a novel incentive computation framework implemented by the unified incentive device of FIG. 1, according to an embodiment of the present disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

Definitions of one or more terms that will be used in this disclosure are described below without limitations. For a person skilled in the art, it is understood that the definitions are provided just for the sake of clarity, and are intended to include more examples than just provided below.

A “target incentive” is used in the present disclosure in the context of its broadest definition. The target incentive may refer to a monetary budget predefined by an organization for an employee. It may be a predefined portion (e.g., a percentage) of the gross salary of the employee.

A “quality of work” is used in the present disclosure in the context of its broadest definition. The quality of work may refer to a measure of accuracy computed by a ratio of a set of one or more error-free work items and a total number of work items.

A “key performance indicator” is used in the present disclosure in the context of its broadest definition. The key performance indicator (KPI) may refer to performance parameters used to measure the performance of employees in an organization. Examples of a KPI may include work duration, quality of work, work complexity, etc.

A “positive KPI” is used in the present disclosure in the context of its broadest definition. The positive KPI may refer to a KPI for which a high value is desirable, e.g., work duration.

A “negative KPI” is used in the present disclosure in the context of its broadest definition. The negative KPI may refer to a KPI for which a low value is desirable, e.g., number of errors.

A “high performer” is used in the present disclosure in the context of its broadest definition. The high performer may refer to a person or an artificial intelligence (Al) system for whom each associated positive KPI has a value relatively greater than a predefined high KPI threshold and each associated negative KPI has a value relatively less than a predefined low KPI threshold.

A “low performer” is used in the present disclosure in the context of its broadest definition. The low performer may refer to a person or an artificial intelligence (Al) system for whom each associated positive KPI has a value relatively less than the predefined high KPI threshold value and each associated negative KPI has a value relatively greater than the predefined low KPI threshold.

A “bid” is used in the present disclosure in the context of its broadest definition. The bid may refer to an offer capable of influencing a task outcome. The bid may be raised by an employee to achieve an intended outcome in an organization.

A “baseline” is used in the present disclosure in the context of its broadest definition. The baseline may refer to an estimated parameter (e.g., time) related to the completion of a task.

A “routine task” is used in the present disclosure in the context of its broadest definition. The routine task may refer to a well-characterized task that has a predefined baseline (e.g., completion time) and assignment policies (or allocation criteria). The routine task is typically pre-assigned to an employee in an organization. The routine task may be regular or day-to-day tasks in an organization.

A “special task” is used in the present disclosure in the context of its broadest definition. The special task may refer to introductory or ad-hoc tasks that do not have a predefined baseline or allocation criteria. The special task may be targeted to fulfill new business requirements and is mutually exclusive to the routine task. In other words, an employee can only operate on one of the special task and the routine task at a particular time instant and not simultaneously in an organization. Examples of the special tasks may include or relate to, but not limited to, unexpected problems in a production environment, un-anticipated customer support, on-boarding a new client in a business, and so on.

### OVERVIEW

Embodiments describe systems and methods to implement an incentive scheme framework in a task-oriented services environment. The embodiments include a unified incentive device that preserves the disparate nature of key performance indicators (KPIs) and combines such KPIs to provide a novel incentive scheme. The unified incentive device classifies disparate KPIs into predefined categories (e.g., combinable, outcome-influencing, unrelated etc.) and unify them to compute an incentive amount. Such disparate KPIs are intrinsic to regular tasks in a services business. When there are special projects involved, the unified incentive device promotes competition among the employees and ensures that enterprise objectives are met for executing less characterized work items (e.g., special projects). Furthermore, the unified incentive device ensures fairness among the employees in terms of their invested effort (e.g., quantified in terms of KPIs such as duration of work, complexity of project, quality of work, etc.) and the corresponding incentive that they receive. For example, if a first employee is superior with respect to a second employee in terms of values of all KPIs, the unified incentive device provides higher incentives for the first employee. Thus, the unified incentive device produces high business value proposition for service delivery enterprises. The unified incentive device provides a scientific basis to design a fair incentive scheme when variety of tasks are involved and disparate KPIs are used to track employee performance. Additionally, the unified incentive device computes balanced incentives for both the routine and special tasks to reduce attrition in services business by retaining high performers and boost productivity by pushing low-performers.

### EXEMPLARY EMBODIMENTS

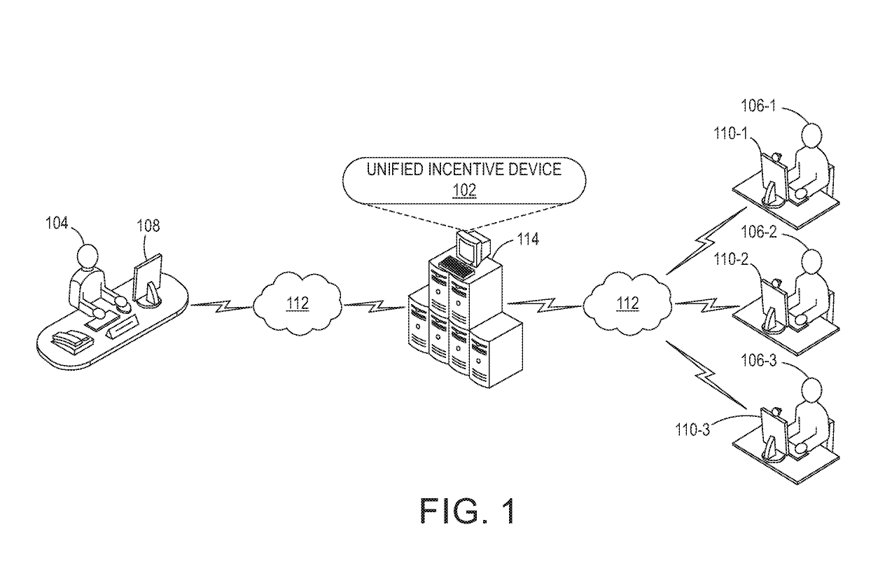

FIGS. 1-5 are schematics of network environments including an exemplary unified incentive device, according to an embodiment of the present disclosure. Some embodiments are disclosed in the context of task-oriented services enterprise such as software firms, call centers, etc. However, other embodiments may include or otherwise cover enterprises that provide various on-demand services (e.g., housekeeping services, utility services such as Internet services and plumbing services, installation services, etc.), location-based services (e.g., tourist guide services, food services, mobile services, etc.), transport services (e.g., delivery services, moving services, courier services, etc.), marketing/sales services (e.g., content creation services, training services, advertisement services, analytics services, etc.), and so on.

Embodiments may include a unified incentive device 102 that interfaces between a supervisor 104 and one or more employees 106-1, 106-2, and 106-3 (collectively, employees 106) of a services enterprise, where they remotely interact with each other in different network environments. In some embodiments, the supervisor 104 and the employees 106 may interact at a common geographical location, for example, within the same office building. The supervisor 104 and the employees 106 may communicate with each other using a supervisor user device 108 (S-user device 108) and employee user devices 110-1, 110-2, and 110-3 (collectively, E-user devices 110) respectively over a network 112.

The S-user device 108 may be implemented as any of a variety of computing devices, including, for example, a server, a desktop PC, a notebook, a workstation, a personal digital assistant (PDA), a mainframe computer, a mobile computing device (e.g., a mobile phone, a tablet, etc.), an internet appliance, and so on. The S-user device 108 may be configured to exchange at least one of text messages, audio interaction data (for example, voice calls, recorded audio messages, etc.), and video interaction data (for example, video calls, recorded video messages, etc.) with the E-user devices 110, or in any combination thereof. The E-user devices 110 may include calling devices (for e.g., a telephone, an internet phone, etc.), texting devices (e.g., a pager), or computing devices including those mentioned above.

In a first exemplary network environment (FIG. 1), the S-user device 108 may communicate with the E-user devices 110 via a server 114 over the network 112. The network 112 may include any software, hardware, or computer applications that can provide a medium to exchange signals or data in any of the formats known in the art, related art, or developed later. The communication network 112 may include, but is not limited to, social media platforms implemented as a website, a unified communication application, or a standalone application. Examples of the social media platforms may include, but are not limited to, Twitter™, Facebook™, Skype™, LinkedIn™, Microsoft Lync™, Cisco Webex™, and Google Hangouts™. Further, the network 112 may include, for example, one or more of the Internet, Wide Area Networks (WANs), Local Area Networks (LANs), analog or digital wired and wireless telephone Networks (e.g., a PSTN, Integrated Services Digital Network (ISDN), a cellular network, and Digital Subscriber Line (xDSL), Wi-Fi, radio, television, cable, satellite, and/or any other delivery or tunneling mechanism for carrying data. The network 112 may include multiple networks or sub-networks, each of which may include, for example, a wired or wireless data pathway. The network 112 may include a circuit-switched voice network, a packet-switched data network, or any other network able to carry electronic communications. For example, the network 112 may include networks based on the Internet protocol (IP) or asynchronous transfer mode (ATM), and may support voice using, for example, VoIP, Voice-over-ATM, or other comparable protocols used for voice, video, and data communications.

In said embodiment (FIG. 1), the server 114 may be installed, integrated, or operated with a unified incentive device 102 configured to at least one of: (1) communicate synchronously or asynchronously with one or more software applications, databases, storage devices, or appliances operating via same or different communication protocols, formats, database schemas, platforms or any combination thereof, to receive data; (2) collect, record, and analyze data including routine tasks, special tasks, organizational constraints or objectives, incentives, and so on; (3) receive, execute, communicate, formulate, train, or categorize one or more mathematical models for trust measurement, task allocation and incentive computation for routine tasks and special tasks separately; (4) design and implement a unified, balanced incentive scheme for both the routine tasks as well as the special tasks; (5) classify and combine disparate key performance indicators (KPIs) to compute an incentive amount for the routine tasks; (6) receive bids of one or more baselines for the special tasks from the employees; (7) fairly calculate higher incentives for high performers; (8) measure trust of the users/employees to identify eligible bids for the special tasks; (9) allocate the special tasks to users (or employees) based on their submitted baselines; (10) determine maximum incentive amount for the special tasks based on the measured trust of the user/employees and their respective submitted baselines; (11) penalize low-performers by reducing their incentive when the preset baselines for the special tasks are not met; and (12) transfer or map the models, tasks, shared parameter, data or datasets, computed incentive amounts; combined KPIs, predefined KPI categories or any combination thereof to one or more networked computing devices and/or data repositories.

The unified incentive device 102 may represent any of a wide variety of devices capable of providing incentive computation for task-oriented services to the network devices. Alternatively, the unified incentive device 102 may be implemented as a software application or a device driver. The unified incentive device 102 may enhance or increase the functionality and/or capacity of the network, such as the network 112, to which it is connected. In some embodiments, the unified incentive device 102 may be also configured, for example, to perform e-mail tasks, security tasks, network management tasks including IP address management, and other tasks. In some other embodiments, the unified incentive device 102 may be further configured to expose its computing environment or operating code to a user, and may include related art I/O devices, such as a keyboard or display. The unified incentive device 102 of some embodiments may, however, include software, firmware, or other resources that support the remote administration and/or maintenance of the unified incentive device 102.

In further embodiments, the unified incentive device 102 either in communication with any of the networked devices such as the server 114, or independently, may have video, voice or data communication capabilities (e.g., unified communication capabilities) by being coupled to or including, various imaging devices (e.g., cameras, printers, scanners, medical imaging systems, etc.), various audio devices (e.g., microphones, music players, recorders, audio input devices, speakers, audio output devices, telephones, speaker telephones, etc.), various video devices (e.g., monitors, projectors, displays, televisions, video output devices, video input devices, camcorders, etc.), or any other type of hardware, in any combination thereof. In some embodiments, the unified incentive device 102 may comprise or implement one or more real time protocols (e.g., session initiation protocol (SIP), H.261, H.263, H.264, H.323, etc.) and non-real-time protocols known in the art, related art, or developed later to facilitate data transfer between the S-user device 108, the E-user devices 110, the server 114, the unified incentive device 102, and any other network device.

In some embodiments, the unified incentive device 102 may be configured to convert communications, which may include instructions, queries, data, etc., from the S-user device 108 or the E-user devices 110 into appropriate formats to make these communications compatible with the server 114 and vice versa. Consequently, the unified incentive device 102 may allow implementation of the S-user device 108 or the E-user devices 110 using different technologies or by different organizations, for example, a third-party vendor, managing the server 114 or associated services using a proprietary technology.

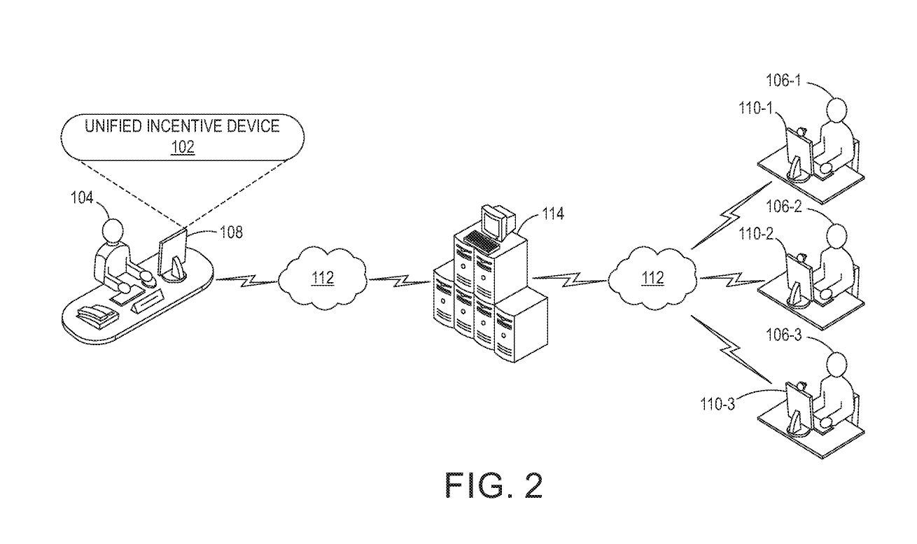

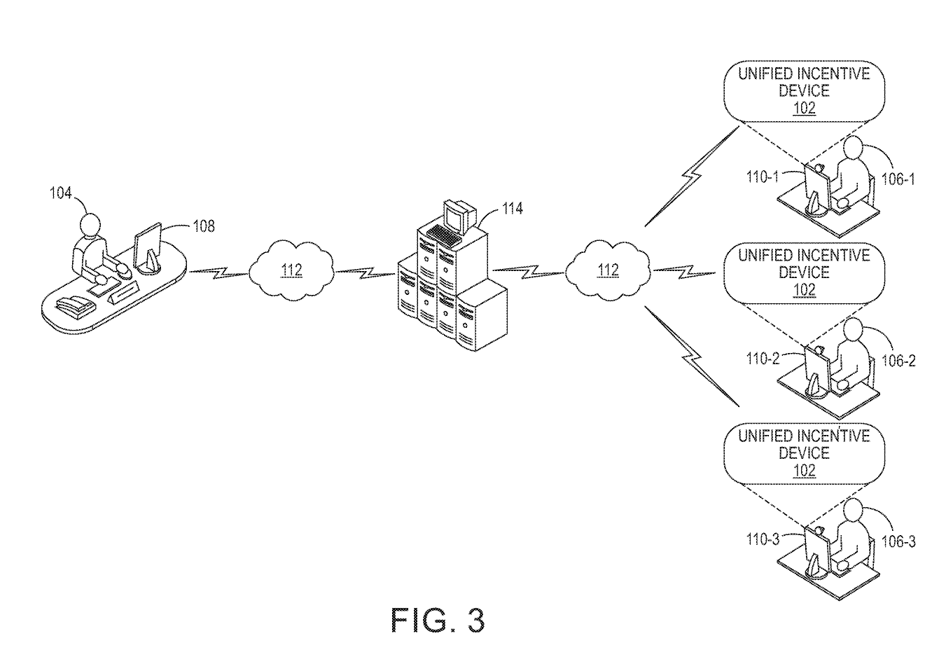

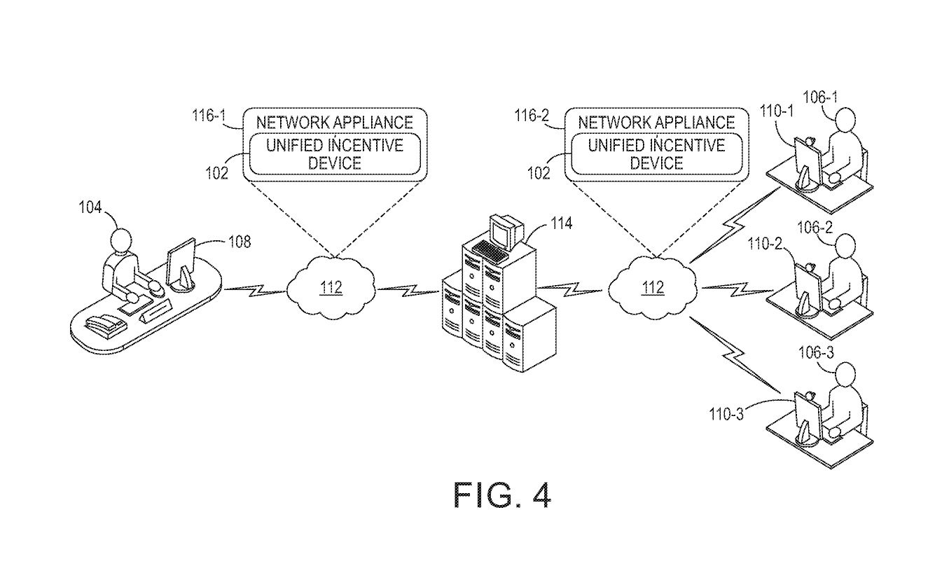

In a second embodiment, the unified incentive device 102 may integrate, install, or operate with the S-user device 108 (FIG. 2) or any of the E-user devices 110 (FIG. 3), or any combination thereof including multiple devices (not shown) that are operatively connected or networked together. In a third embodiment (FIG. 4), the unified incentive device 102 may be installed on or integrated with one or more network appliances 116-1 and 116-2 (collectively, network appliances 116) configured to establish the network 112 between the S-user device 108, E-user devices 110, and the server 114. At least one of the unified incentive device 102 and the network appliances 116 may be capable of operating as or providing an interface to assist the exchange of software instructions and data among the S-user device 108, E-user devices 110, the server 114, and the unified incentive device 102. In some embodiments, the network appliances 116 may be preconfigured or dynamically configured to include the unified incentive device 102 integrated with other devices. For example, the unified incentive device 102 may be integrated with the server 114 (as shown in FIG. 1) or any other computing device (not shown) connected to the network 112. The server 114 may include a module (not shown), which enables the server 114 being introduced to the network appliances 116, thereby enabling the network appliances 116 to invoke the unified incentive device 102 as a service. Examples of the network appliances 116 include, but are not limited to, a DSL modem, a wireless access point, a router, a base station, and a gateway having a predetermined computing power and memory capacity sufficient for implementing the unified incentive device 102.

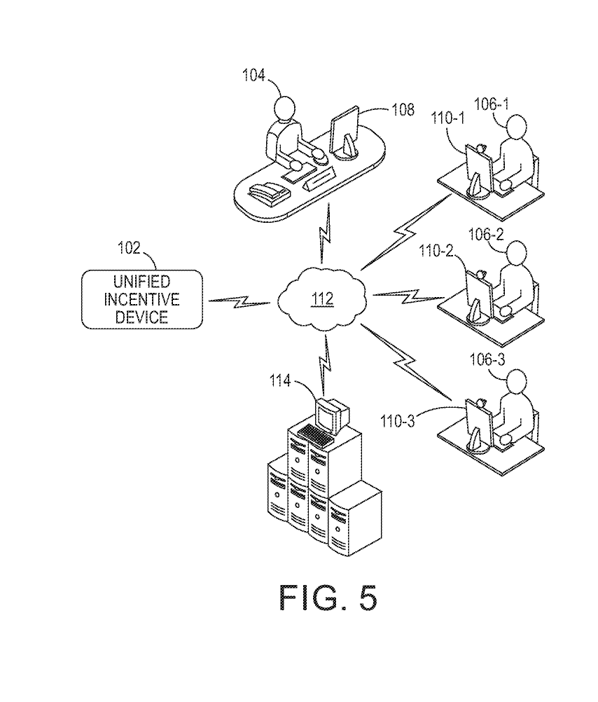

In a fourth embodiment (FIG. 5), the unified incentive device 102 may be a standalone device. The unified incentive device 102 may include its own processor (not shown) and a transmitter and receiver (TxRx) unit (not shown). In this embodiment, the unified incentive device 102, the S-user device 108, the E-user devices 110, the server 114, and the unified incentive device 102 may be implemented as dedicated devices communicating with each other over the network 112. Accordingly, the unified incentive device 102 may communicate directly with the networked devices (e.g., the S-user device 108, the E-user devices 110, the server 114, etc.) using the TxRx unit.

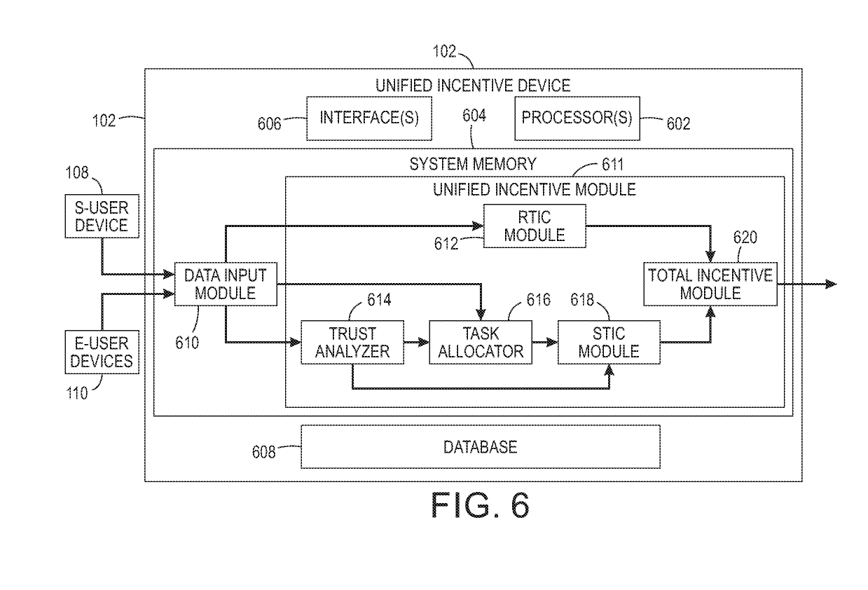

Further, as illustrated in FIG. 6, the unified incentive device 102 may be implemented by way of a single device (e.g., a computing device, a processor or an electronic storage device) or a combination of multiple devices that are operatively connected or networked together. The unified incentive device 102 may be implemented in hardware or a suitable combination of hardware and software. In some embodiments, the unified incentive device 102 may be a hardware device including processor(s) 602 executing machine readable program instructions to (1) classify and successively combine disparate KPIs into multiple categories to provide a unique set of KPIs used for computation of an incentive amount for the routine tasks; (2) receive bids of one or more baselines for the special tasks; (3) fairly calculate higher incentives for high performers; (4) measure trust of the users/employees to identify eligible bids for the special tasks; (5) allocate the special tasks to users (or employees) based on their computed trust and/or submitted baselines; (6) determine maximum incentive amount for the special tasks based on the measured trust of and submitted baselines by the user/employees; (7) penalize underperformers when the preset baselines for the special tasks are not met; and (8) compute a balanced incentive based on the effort invested in the routine tasks and the special tasks. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) 602 may include, for example, microprocessors, microcomputers, microcontrollers, digital signal processors, central processing units, state machines, logic circuits, and/or any devices that manipulate signals based on operational instructions. Among other capabilities, the processor(s) 602 may be configured to fetch and execute computer-readable instructions in a system memory 604 associated with the unified incentive device 102 for performing tasks such as signal coding, data processing input/output processing, power control, and/or other functions.

In some embodiments, the unified incentive device 102 may include, in whole or in part, a software application working alone or in conjunction with one or more hardware resources. Such software application may be executed by the processor(s) 602 on different hardware platforms or emulated in a virtual environment. Aspects of the unified incentive device 102 may leverage known, related art, or later developed off-the-shelf software. Other embodiments may comprise the unified incentive device 102 being integrated or in communication with a mobile switching center, network gateway system, Internet access node, application server, IMS core, service node, or some other communication systems, including any combination thereof. In some embodiments, the unified incentive device 102 may be integrated with or implemented as a wearable device including, but not limited to, a fashion accessory (e.g., a wristband, a ring, etc.), a utility device (a hand-held baton, a pen, an umbrella, a watch, etc.), a body clothing, a safety gear, or any combination thereof.

The unified incentive device 102 may also include a variety of known, related art, or later developed interfaces such as interface(s) 606, including software interfaces (e.g., an application programming interface, a graphical user interface, etc.); hardware interfaces (e.g., cable connectors, a keyboard, a card reader, a barcode reader, a biometric scanner, an interactive display screen, a transmitter circuit, a receiver circuit, etc.); or both.

The unified incentive device 102 may further include the system memory 604 for storing, at least, one of (1) files and related data including metadata, for example, data size, data format, creation date, associated tags or labels, related videos, images, documents, messages or conversations, etc.; (2) a log of profiles of network devices and associated communications including instructions, queries, conversations, data, and related metadata; and (3) predefined or dynamically defined or calculated mathematical models or equations for incentive computation, and parameters or incentive amounts.

The system memory 604 may comprise of any computer-readable medium known in the art, related art, or developed later including, for example, a processor or multiple processors operatively connected together, volatile memory (e.g., RAM), non-volatile memory (e.g., flash, etc.), disk drive, etc., or any combination thereof. The system memory 604 may include one or more databases such as a database 608, which may be sub-divided into further databases for storing electronic files or data. The system memory 604 may have one of many database schemas known in the art, related art, or developed later for storing the data, predefined or dynamically defined models, and parameter values. For example, the database 608 may have a relational database schema involving a primary key attribute and one or more secondary attributes. In some embodiments, the unified incentive device 102 may perform one or more operations including, but not limited to, reading, writing, deleting, indexing, segmenting, labeling, updating, and modifying the data, or a combination thereof, and may communicate the resultant data to various networked computing devices.

In one embodiment, the system memory 604 may include various modules such as a data input module 610 and a unified incentive module 611, which may further include a routine task incentive computation (RTIC) module 612, a trust analyzer 614, a task allocator 616, a special task incentive computation (STIC) module 618, and a total incentive module 620. The data input module 610 may receive a variety of data including employee records, organizational constraints, and special tasks from the S-user device 108 or the server 114. The employee records may include various details of one or more employees, ε={e₁, e₂, . . . , eᵢ}. Examples of such details include, but not limited to, employment data (e.g., name, employee ID, designation, tenure, experience, previous organization(s), supervisor name, supervisor employee ID, etc.), demographic data (e.g., gender, race, age, education, accent, income, nationality, ethnicity, area code, zip code, marital status, job status, etc.), psychographic data (e.g., introversion, sociability, aspirations, hobbies, etc.), system access data (e.g., login ID, password, biometric data, etc.), and so on.

For each employee eᵢ, the organization may maintain an individual record including various details related to the employee's performance in past projects. In one embodiment, the data input module 610 may receive performance history of the employee e₁ with the employee records. The performance history may include, but not limited to, a number of previously assigned tasks (Aᵢ), a number of baseline violations (Nᵢ) associated with the employee eᵢ, a percentage deviation from each baseline that has been violated, and so on. Such percentage deviation, or percentage baseline violation, may be denoted by DVᵢ={d₁, d₂, . . . , dₗ_{ᵢ}}, ∀i∈{1, 2, . . . , lᵢ}, dᵢ∈[0,1], in which, for e.g., d₁ being 50% may be equivalent to 0.5.

The organizational constraints may include a variety of KPIs for each employee, where these KPIs may relate to one or more internal and external control objectives. The internal control objectives may refer to the reliability of financial reporting, timely feedback on the achievement of operational or strategic goals, and compliance with laws and regulations. For example, the internal control objectives may relate to, without limitation, (1) equipment (e.g., availability details, maintenance cycle, usage training, etc.), (2) people (e.g., technical skills, soft skills, positive or negative behaviors, etc.), (3) policies (e.g., business hours, data access restriction, percentage of business travel, etc.), or any combination thereof. On the other hand, the external control objectives may refer or relate to short-term and long-term implications of decisions made within the organizations on business goals. For example, the external control objectives may relate to, without limitation, (1) resource status (e.g., limited availability of essential inputs (including skilled labor), key raw materials, energy, specialized machinery and equipment, warehouse space, investment funds, etc.), (2) contractual obligations (e.g., labor contracts, product or service licenses, etc.), (3) laws and regulations (e.g., minimum wage, health and safety standards, fuel efficiency requirements, anti-pollution regulations, fair pricing and marketing practices, etc.), or any combination thereof.

Further, the data input module 610 may receive one or more tasks from any of the networked devices such as the server 114, the S-user device 108, and the E-user devices 110. In one embodiment, the data input module 610 may be configured to identify a type of the task based a predetermined baseline being associated with the task. For example, the data input module 610 may be configured to identify a received task as a routine task if the task is associated with the predetermined baseline. However, the data input module 610 may identify the task as a special or exploratory task if no baseline is pre-associated with or predefined for the task. Based on the identified type of task, (1) for the routine task, the data input module 610 may operate in tandem with the RTIC module 612, and/or (2) for the special task, the data input module 610 may operate in tandem with the trust analyzer 614, the task allocator 616, and the STIC module 618. In some embodiments, the data input module 610 may directly communicate with the STIC module 618. The special task and the routine task may be mutually exclusive to each other. In other words, an employee may not work on the routine task and the special task simultaneously. In some embodiments, the RTIC module 612 and the STIC module 618 may be integrated with each other.

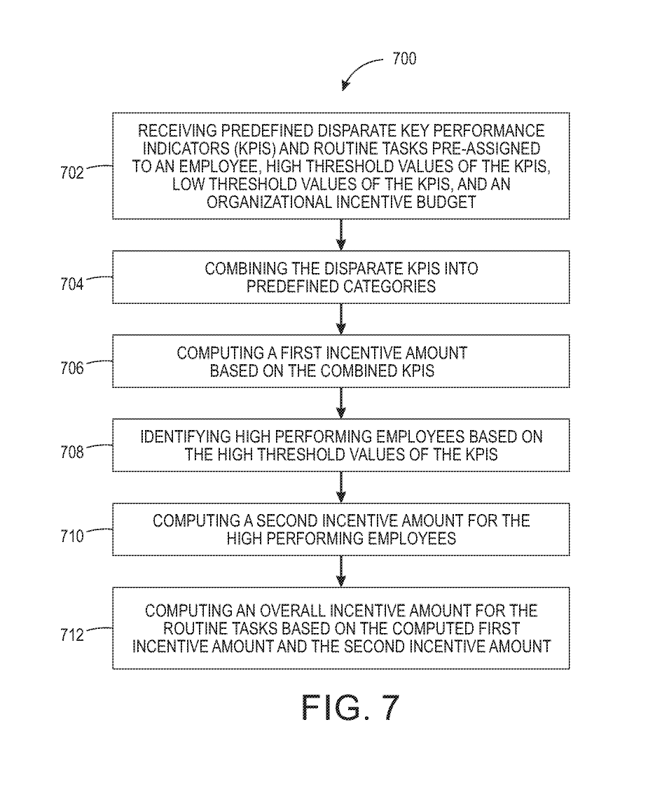

Further operation of the data input module 610 and the RTIC module 612 is discussed with reference to FIG. 7, which illustrates an exemplary method of implementing the RTIC module 612 working in communication with the data input module 610. The exemplary method 700 may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 700 is described is not intended to be construed as a limitation, and any number of the described method blocks may be combined or otherwise performed in any order to implement the method or an alternate method. Additionally, individual blocks may be deleted from the method without departing from the spirit and scope of the present disclosure described herein. Furthermore, the method 700 may be implemented in any suitable hardware, software, firmware, or combination thereof, that exists in the related art or that is later developed.

The method 700 describes, without limitation, implementation of the exemplary RTIC module 612. One of skill in the art will understand that the method 700 may be modified appropriately for implementation in various manners without departing from the scope and spirit of the disclosure. The method 800 may be implemented, in at least some embodiments, by the RTIC module 612 of the unified incentive device 102. For example, the RTIC module 612 may be configured using the processor(s) 602 to execute computer instructions to perform operations for classifying and combining the disparate KPIs of each employee eᵢ.

At 702, in one embodiment, the organizational constraints received by the data input module 610 may include routine tasks, their related key performance indicators (KPIs), priorities of these KPIs, a high threshold value and/or a low threshold value for each KPI. The routine tasks may be denoted by T={t₁, t₂, . . . , tₘ} that are being pre-assigned to each employee. For example, the routine tasks in a call center enterprise may include, but not limited to, answer customer calls, process online forms, train subordinates, prepare sales report, provide operation status update to stakeholders, etc. Each routine task may be associated with a variety of disparate key performance indicators (KPIs), P={(p₁, p₁, . . . , pₖ}, each having a predetermined high threshold value based on its predefined objective(s). The predetermined high threshold value may be used to determine high performers, discussed later in greater detail.

In some embodiments, an opposite threshold value may also be predefined for one or more KPIs. For example, a low threshold value may be defined for the KPI “quality of work” in addition to a high threshold value, so that a set of employees for whom the value of this KPI is below the low threshold value, may be identified as low performers. One having ordinary skill in the art will be able to appropriately associate high or low threshold values, or both, to one or more KPIs for the routine tasks. Such high and low threshold values of the KPIs may be relative to each other. The employees may be rewarded based on a balancing between the KPIs, P, of the routine tasks T that they may perform. In some embodiments, the KPIs vectors Vᵢ may be determined for each month for each employee, i.e., eᵢ∈ε, as shown in Equation 1.

Vᵢ={vᵢ₁,vᵢ₂, . . . ,vᵢₖ} (1)

where:

vᵢⱼ=value of a KPI pⱼ for an employee eᵢ for a month M

The data input module 610 may also receive an organizational incentive budget and a target incentive Bᵢ for each employee eᵢ. The organizational incentive budget which may be represented as shown in Equation 2. The data input module 610 may store the received data in the database and/or communicate it to the RTIC module 612, the trust analyzer 614, and the task allocator 616.

B=B₁+B₂ (2)

where:

B₁=Total incentive budget for the routine tasks T including a special budget for high performers

B₂=Incentive budget for the special tasks T′ including a budget B′ for each special task t′ᵢ (i.e., t′ᵢ∈T′) assigned to each employee eᵢ, such that Σᵢ₌₀^{m′}B′ᵢ=B₂.

### Incentive Calculation for Routine Tasks

As illustrated in FIG. 7, the RTIC module 612 may be configured to (1) analyze, classify, and combine the disparate KPIs; (2) compute an incentive amount for all the routine tasks based on the combined KPIs; and (3) compute an incentive amount for one or more employees (i.e., high performers) who have performance higher than others.

At 704, in order to compute the incentive amount for the routine tasks, the RTIC module 612 may analyze, classify, and successively combine the disparate KPIs into predefined categories. In one embodiment, the RTIC module 612 may combine the disparate KPIs under predefined categories of combinable KPIs, outcome-influencing KPIs, and unrelated KPIs. One having ordinary skill in the art may further extend or add new or sub categories under which the disparate KPIs may be successively combined without deviating from the scope and spirit of the present disclosure.

Under the category of combinable KPIs, the RTIC module 612 may combine KPIs that are expected to be of same type with same dimension. In other words, the combinable KPIs have similar impact on the outcome of a business objective. For example, in a software development environment, the KPIs “system login time” and the time spent on a routine task, i.e., “project time,” both may describe the time spent and have the same dimension of hours or minutes. As a result, the RTIC module 612 may combine the values of KPIs “system login time” and the “project time.” The RTIC module 612 may accordingly define a combinable incentive parameter K′ as shown in Equation 3A. The incentive of an employee may depend on the value of K′.

K′=Σᵢ₌₁^{r}αᵢ*kᵢ (3A)

where:

kᵢ∈(k₁, k₂, . . . , kᵣ)=K, which is a set of combinable KPIs

αᵢ∈(α₁, α₂, . . . , αᵢ) is the priority of kᵢ∈K

Once the KPIs are combined, the RTIC module 612 may handle KPIs with conflicting objectives in a KPI set comprising combined KPIs K′ as shown in Equation 3B.

K₁={K′₁,K′₂, . . . K′_{d}} (3B)

where:

K₁=Non-combinable KPIs

K′ᵢ=Unified set of combinable KPIs, where, i=1, 2, . . . , d

The KPIs K₁ may be referred to as non-combinable KPIs as they may be neither completely independent nor combinable and are based on their outcome influence on the incentive amount. The non-combinable KPIs have a causal relationship with the combinable KPIs based on equation 3B in terms that the non-combinable KPIs are extracted from the set of combined or unified combinable KPIs. The RTIC module 612 may be configured to identify the set of non-combinable KPIs as being outcome-influencing if: (1) the low (i.e., undesired) absolute value of a KPI is reflected in the incentive amount and (2) that KPI reduces the effect of other high (i.e., desired) absolute valued KPIs belonging in the same set. In other words, if an employee wants to get more incentive, it is not really possible to increase the incentive amount significantly by compromising one KPI value and improving the other KPI values in the outcome-influencing set of KPIs. For example, with respect to the KPIs, namely, “work duration” and the “quality of the work”, an employee having a very high value for the KPI “work duration” but a very low value for the KPI “quality of the work” may not be typically eligible for a high incentive. Therefore, the “work duration” and the “quality of the work” may be identified as outcome-influencing KPIs by the RTIC module 612 for computing the incentive amount for the routine tasks.

The outcome-influencing KPIs may take values in different ranges. For example, the “work duration” may take a value from a set of positive real numbers (unbounded set), whereas the “quality of the work,” which may be calculated in percentage, may take a value from a bounded set, e.g., ranging from zero to one hundred, i.e., [0, 100]. As a result, the RTIC module 612 may be configured to normalize the values of the outcome-influencing KPIs instead of using the absolute values of such KPIs. The RTIC module 612 may compute a normalized value NoV(vᵢⱼ) for an employee eᵢ and each KPI, kⱼ∈K₁={K′₁, K′₂, . . . K_{d}} where K₁ is a set of outcome-influencing KPIs, as shown in Equation 4.

$$NoV ( {v}_{ij} ) = \frac{{v}_{ij} - {L}_{j}}{{U}_{j} - {L}_{j}} \qquad ( 4 )$$

where:

vᵢⱼ=value of an outcome-influencing KPI K′ⱼ for an employee eᵢ

Lⱼ=an acceptable low limit for K′ⱼ

Uⱼ=a desirable high limit for K′ⱼ

As shown in Equation 4, the normalized value increases for each of the outcome-influencing KPIs based on the absolute value of the KPIs, irrespective of their respective objective. In other words, the normalized value is not dependent on whether a value of a KPI needs to be high or low to meet the associated objective. Further as the value of NoV(vᵢⱼ) can be negative or more than the value ‘1,’ the RTIC module 612 may define a super normalized parameter for an employee and a KPI kⱼ as shown in Equation 5.

$${δ}_{ij} = \{ \begin{matrix}1 , & if NoV ( {v}_{ij} ) \geq 1 \\ 0 , & if NoV ( {v}_{ij} ) \leq 0 \\ NoV ( {v}_{ij} ) , & Otherwise\end{matrix} \qquad ( 5 )$$

The RTIC module 612 may be configured to take into account the values of all the outcome-influencing KPIs together for quantifying the performance of an employee. For this, the RTIC module 612 may compare the normalized values of all the outcome-influencing KPIs based on Equations 6 and 7A.

$$\begin{matrix}{μ}_{i} = \frac{{\sum }_{j = 1}^{d} ( {δ}_{ij} * {β}_{j} )}{{\sum }_{j = 1}^{d} {β}_{j}} & ( 6 ) \\ {σ}_{i} = {\sum }_{j = 1}^{d} ( {σ}_{ij} * \frac{{β}_{j}}{{\sum }_{l = 1}^{d} {β}_{l}} ) & ( 7 A )\end{matrix}$$

where:

β₁, β₂, . . . , β_{d}=Priority of the KPIs K₁={k₁, k₂, . . . , k_{d}}

$${σ}_{ij} = \{ \begin{matrix}0 , & if {μ}_{i} \leq {δ}_{ij} \\ {μ}_{i} - {δ}_{ij} , & Otherwise\end{matrix} = Average KPI deviation \qquad ( 7 B )$$

where:

μᵢ=Average KPI value

In one embodiment, based on Equations 6, 7A and 7B, the RTIC module 612 may define a performance parameter λᵢ shown in Equation 8 for each employee for the set of outcome-influencing KPIs. The performance parameter λᵢ may define the performance of an employee in terms of the KPI values and their overall spread.

λᵢ=μᵢ−σᵢ (8)

In one exemplary scenario, when more than one employee, for example, two employees, have the same value of μ for a set of the outcome-influencing KPIs, the RTIC module 612 may be preconfigured or dynamically configured to determine different incentive amount for each such employees based on the value of σ, i.e., average KPI deviation, of that set. For this, the RTIC module 612 uses Equation 7B to determine Equation 9.

σᵢⱼ≦μᵢ (9)

### Therefore,

$${σ}_{i} = {\sum }_{j = 1}^{d} ( {σ}_{ij} * \frac{{β}_{j}}{{\sum }_{l = 1}^{d} {β}_{l}} ) \leq {\sum }_{j = 1}^{d} ( {μ}_{i} * \frac{{β}_{j}}{{\sum }_{l = 1}^{d} {β}_{l}} ) = {μ}_{i}$$

where:

$${\sum }_{j = 1}^{d} ( \frac{{β}_{j}}{{\sum }_{l = 1}^{d} {β}_{l}} ) = 1 \\ 0 \leq {μ}_{i} - {σ}_{i} \qquad ( 10 )$$

Upon comparing Equations 8 and 10, the RTIC module 612 determines that the performance parameter λᵢ is always non-negative. Moreover, since σᵢ≧0 and λᵢ≦μᵢ based on Equations 7B, 8, and 10, the RTIC module 612 may bound the performance parameter λᵢ within a predefined range, for example, λᵢ∈[0,1] based on Equations 11 and 12.

If μᵢ≦1, then λᵢ≦1 (11)

Since μᵢ≧σᵢⱼ based on Equation 9, then λᵢ is minimum when μᵢ=σᵢⱼ (12)

Further, the RTIC module 612 may be preconfigured or dynamically configured to ensure that fair performance, i.e., λᵢ, of each employee is determined for fair calculation of the incentive amount even when the average value μᵢ of the output influencing KPIs is same for a set of employees. Let K₁={k₁, k₂, . . . , kᵣ} be a set of outcome-influencing KPIs, where two employees, e₁ and e₂, with KPI vectors {v₁₁, v₁₂, . . . , v_{1d}} and {v₂₁, v₂₂, . . . , v_{2d}} respectively, such that ∀i, δ₂ᵢ=δ₁ᵢ+Δᵢ, where Δᵢ≧0, i.e., e₂ has better values for all KPIs than e₁. Accordingly, the value of performance parameter of the employee e₂ needs to be greater than that of employee e₁, i.e., λ₂≧λ₁, for fair evaluation of respective incentive amounts. For this scenario, the RTIC module 612 may use predefined Equations 13 and 14 to determine the values of μ₁, μ₂ and μΔ based on the values of the super normalized parameter, i.e., {δ₁ᵢ} and {δ₂ᵢ}, for both the employees and a small increment value {Δᵢ}.

δ₂ᵢ=δ₁ᵢ+Δᵢ (13)

μ₂=μ₁+μΔ (14)

Based on Equations 13 and 14, the RTIC module 612 may evaluate the value of Equation 15 for various conditions.

∀i(μ₂−δ₂ᵢ)=(μ₁+μΔ)−(δ₁ᵢ+Δᵢ)=(μ₁−δ₁ᵢ)+(μΔ−Δᵢ) (15)

In one exemplary condition, when (μ₂−δ₂ᵢ)≧0 or (μ₂−δ₂ᵢ)<0 in Equation 15, then Equation 16 being true, the RTIC module 612 may determine Equation 18 based on Equations 17 and 7B as σ₁ᵢ is equal to zero if the average value of KPIs, i.e., μ₁, for the employee e₁ is negative.

(μ₁−δ₁ᵢ)>0 and(μΔ−Δᵢ)>0 (16)

σ₂ᵢ=σ₁ᵢ+σ_{Δi} (17)

σ₂ᵢ≦σ₁ᵢ+σ_{Δi} (18)

Further, the RTIC module 612 may determine Equations 19-22 based on Equations 9 and 18.

μΔ≧σΔ (19)

[symbol]

(μ₂−μ₁)≧σΔ≧(δ₂−δ₁) (20)

[symbol]

(μ₂−σ₂)≧(μ₁−σ₁) (21)

[symbol]

λ₂≧λ₁ (22)

Equations 19-22 imply that the RTIC module 612 fairly determines the performance parameter λᵢ for fair calculation of the incentive amount. Therefore, the RTIC module 612 replaces a set of outcome-influencing KPIs by a single KPI with a representative value of the performance parameter λ, which represents the performance of the employees. However, there may still be one or more KPIs left with a set of unrelated KPIs that are neither combinable nor outcome-influencing.

Furthermore, the RTIC module 612 may handle the unrelated KPIs, which may be denoted by K₂={k₁, k₂, . . . , k_{r′}}, where each k_{r′}∈K₂ has a representative λ_{r′}. Accordingly, the unrelated KPIs, K₂, have a causal relationship with the outcome-influencing KPIs, K₁. The unrelated KPIs K₂ may have predefined priorities γ₁, γ₂ . . . γᵣ received from the data input module 610. Therefore, the RTIC module 612 may successively combine the disparate KPIs into predefined categories ranging from the combinable KPIs to the unrelated KPIs via the outcome-influencing KPIs, where the inherent KPIs of at least one category, for example, outcome-influencing KPIs, have causal relationship with another set of KPIs of another category, e.g., combinable KPIs

The values of the unrelated KPIs always reflect in the final incentive amount of an employee, who has a predefined target incentive amount. As these unrelated KPIs cannot influence the effect of each other, the RTIC module 612 may be configured to divide the target incentive amount of an employee into multiple buckets. Each bucket may correspond to an unrelated KPI. The total number of buckets may be r′. For an employee eᵢ, the target incentive amount allocated for each KPI kⱼ∈K₂ is shown in Equation 23.

Subsequently, at 706, the RTIC module 612 may determine a first incentive amount as shown in Equation 24 based on Equation 23 using the combined KPIs computed above.

$${B}_{ij} = {B}_{i} * \frac{{γ}_{j}}{{\sum }_{l = 1}^{{r}^{′}} {γ}_{l}} \qquad ( 23 )$$

where:

Bᵢ=Target incentive amount of an employee eᵢ

Bᵢⱼ=Target incentive amount of an employee eᵢ for unrelated KPI kⱼ

[symbol]

⁽¹⁾(eᵢ)=Σⱼ₌₁^{r′}(Bᵢⱼ*λᵢⱼ) (24)

Further, at 708, in one embodiment, the RTIC module 612 may be preconfigured or dynamically configured to determine high performers. The RTIC module 612 may identify one or more employees as high performers when the value of each of their KPIs exceeds the respective predefined high threshold value, which is a desired upper limit according to an associated organizational/business objective. For example, KPIs such as “work duration” and “quality of work” are positive KPIs that may be desired to have predetermined high threshold values and others such as “average project handling time” and “error rate” are negative KPIs that may be required to have predetermined low threshold values. Therefore, a set of employees who have a value of the KPI “quality of work” exceeds its predetermined high threshold value may be referred to as high performers. Similarly, a set of employees who have a value of the KPI “error rate” being below its low threshold value may be referred to as high performers. The high performers may be denoted as ε′.

At 710, the RTIC module 612 may compute a second or an additional incentive for the identified high performers. Only a subset of the employees may be eligible for this additional incentive amount. The RTIC module 612 may associate a score, ηᵢ, with each high performer, eᵢ, and this score be calculated based on the performance parameter and predefined priorities of the unrelated KPIs, which may be determined as discussed above through Equations 3A to 23. However, the RTIC module 612 may determine the super normalized parameter δᵢⱼ based on Equation 25 instead of using Equation 5.

δᵢⱼ=NoV(vᵢⱼ) (25)

The equation 25 implies that the value of μᵢ, i.e., the average KPI value, can be negative, which can cause the value of the performance parameter λᵢⱼ to be also negative. Hence, the score ηᵢ for each high performer may be calculated as shown in Equation 26.

ηᵢ=Σⱼ₌₁^{r′}γⱼ*λᵢⱼ (26)

The RTIC module 612 may be configured for computing the second incentive amount only for an employee, eᵢ∈ε′, whose associated score ηᵢ is non-negative. The RTIC module 612 may calculate the second incentive amount based on Equation 27.

$${( 2 )}^{} ( {e}_{i} ) = {B}^{′} * \frac{{η}_{i}}{{Σ}_{( j : {e}_{j} ∈ {ɛ}^{′} \& {η}_{j} > 0 )} {η}_{j}} \qquad ( 27 )$$

where:

B′=additional organizational incentive budget for high performance

At 712, the RTIC module 612 may combine the computed first incentive amount based on equation 24, and the second incentive amount based on Equation 27 for the high performers, to output a total incentive amount for each routine task for each employee. For all the employees who are not determined as high performers, or are the low performers, the RTIC module 612 may output only the incentive calculated based on Equation 24. Accordingly, the RTIC module 612 may communicate the computed total incentive amount and/or the individually computed incentives based on equations 24 and 27 to the total incentive module 620.

### Incentive Calculation for Special Tasks

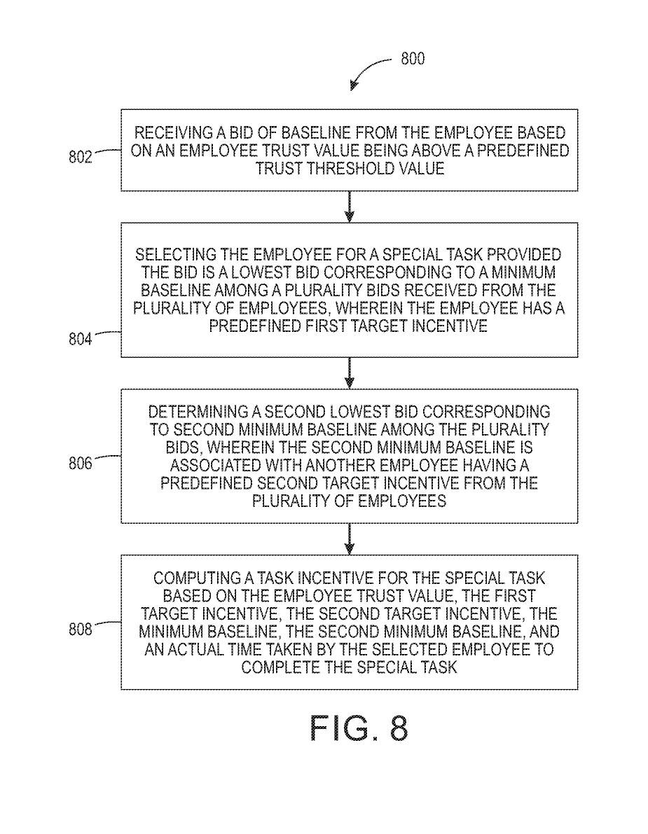

Further operations of the data input module 610, the trust analyzer 614, the task allocator 616, and the STIC module 618 are discussed with reference to FIG. 8, which illustrates an exemplary method of implementing the STIC module 612 working in communication with the data input module 610, the trust analyzer 614, and the task allocator 616. The exemplary method 800 may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 800 is described is not intended to be construed as a limitation, and any number of the described method blocks may be combined or otherwise performed in any order to implement the method or an alternate method. Additionally, individual blocks may be deleted from the method without departing from the spirit and scope of the present disclosure described herein. Furthermore, the method 800 may be implemented in any suitable hardware, software, firmware, or combination thereof, that exists in the related art or that is later developed.

The data input module 610 may identify received tasks as the special tasks, T′={t′₁, t′₂, . . . , t′_{m′}} when no predefined baseline is associated with the task. The special tasks may include various exploratory tasks that are ad-hoc or introductory in nature to achieve business goals. In one exemplary scenario of a call center enterprise, examples of such special tasks may include, but not limited to, define and formulate new type of process forms, perform business analytics for a new customer, analyze new type of customer queries, etc.

For each task t′ in an identified set of special tasks T′, i.e., t′∈T′, the organization has an incentive budget, B′. Once the task t′ is successfully completed, an employee eᵢ can get maximum B′ depending on different factors.

When an employee spends time and effort to perform the set of special tasks, he has to compromise on the incentive amount that he could receive by engaging in only the set of well-characterized routine tasks. However, each special task is associated with an incentive amount that varies across the special tasks and the employees. Such distribution of the time and effort is principally used by unified incentive device 102 to compute a balanced incentive between the routine tasks and the special tasks for each employee.

At 802, a bid of baseline from each employee is received by the STIC module 618 via the data input module 610. In one embodiment, the employees may be encouraged to bid for a special task. The bids may be received by the data input module 610, for example, from the E-user devices 110. Each bid may include a baseline for a special task, where the baseline may refer to a time duration estimated by the employee for completion of the task. Multiple employees may submit the baselines for one task. The organization using the task allocator 616, discussed below in greater detail, may choose a suitable employee for the task depending on his submitted baseline and his previous records, such as the performance history. The trust analyzer 614 may receive the bids and the performance history of the employees from data input module 610 or from the database 608.

The trust analyzer 614 may be configured to measure trust of each employee. The trust analyzer 614 may be preconfigured or dynamically configured to include and measure metrics shown in Equations 28 to 31 that may define trust measure of an employee.

$${ℛ}_{i} = \{ \begin{matrix}0 , & if {A}_{i} = 0 \\ {N}_{i} / {A}_{i} , & Othewise\end{matrix} \qquad ( 28 )$$

where:

Aᵢ=number of assigned tasks

Nᵢ=number of baseline violations

[symbol] =ratio of the baseline violation

$${μ}_{i}^{{T}^{′}} = \frac{{\sum }_{{d}_{i} ∈ {DV}_{i}} {d}_{i}}{\vert {DV}_{i} \vert} \qquad ( 29 )$$

where:

μᵢ^{T′}=average percentage baseline violation

DVᵢ=percentage baseline violation

DVᵢ={d₁, d₂, . . . , dₗ_{ᵢ}}, ∀i∈{1, 2, . . . , lᵢ}, dᵢ∈[0,1]

$${σ}_{i}^{{T}^{′}} = \sqrt{\frac{{\sum }_{{d}_{i} ∈ {DV}_{i}} {( {μ}_{i}^{{T}^{′}} - {d}_{i} )}^{2}}{\vert {DV}_{i} \vert}} \qquad ( 30 )$$

where:

σᵢ^{T′}=standard deviation of the percentage baseline violation, DVᵢ

$${i}_{} = \{ \begin{matrix}0 , & if {μ}_{i}^{{T}^{′}} = 0 \\ {σ}_{i}^{{T}^{′}} / {μ}_{i}^{{T}^{′}} , & Otherwise\end{matrix} \qquad ( 31 )$$

where:

[symbol] i=central tendency of baseline violation

The ratio of the baseline violation ( [symbol] ᵢ), the average percentage baseline violation (μᵢ^{T′}), the standard deviation of the percentage baseline violation (σᵢ^{T′}), and the central tendency of baseline violation ( [symbol] ₁) provide the metrics to define the trust measure. Based on Equations 28-31, the trust analyzer 614 is configured to determine the trust measure (Γᵢ) of an employee as defined in Equation 32.

Γᵢ=(1− [symbol] ᵢ)*(1− [symbol] ᵢ) (32)

Based on Equation 32, if the ratio of baseline violations ( [symbol] ᵢ) and the central tendency ( [symbol] ᵢ) of the baseline increases, the trust measure decreases. Therefore, it is important for an employee to complete the special tasks before the assigned baseline to avoid the trust measure from being adversely affected. Moreover, in some embodiments, the organization may allow only the top KN number of employees, based on their trust measure, to bid for special tasks, where KN may be given by the organization. Such selected bidding only by few employees may be controlled by the trust analyzer 614. The trust analyzer 614 may be preconfigured or dynamically configured to allow only those employees who have their computed trust measure being above a predefined threshold value to bid for the special tasks. For example, if the trust measure of an employee is below a predefined threshold value, the trust analyzer 614 may restrict the received bid of baseline from being communicated to the task allocator 616. Therefore, an employee has to carefully provide or bid for a baseline that avoids them to be restricted by the trust analyzer 614, and so, meets the objective of the organization to complete a special task as quickly and as reliably as possible. Therefore, the trust measure may motivate an employee and guarantee that an employee submits an appropriate baseline for a given task in order to receive maximum incentive amount including that of the special task. In one embodiment, the trust analyzer 614 may determine the trust measure based on the premise that (1) all employees are rational, (2) the employees may communicate with each other while submitting respective baselines for the same task, and (3) each employee has a private belief on the baseline and the employee may actually complete the task within the provided baseline. The trust analyzer 614 may communicate the determined trust measure of each employee and the eligible bids of baselines to the task allocator 616.

At 804, an employee is selected for a special task based on a lowest bid associated with minimum baseline. The task allocator 616 may be configured to assign a special task to at least one employee from a set of employees who have bid for that task. The task allocator 616 may employ any of a variety of techniques known in the art, related art, or developed later to select the employee for assigning the special task. In one embodiment, the task allocator 616 may employ the principle of the classical Vickrey's second auction for the task assignment. Accordingly, the task allocator 616 may select an employee whose submitted baseline is the minimum, irrespective of the trust measure, and assign the special task to the selected employee.

At 806, a second lowest bid associated with a second minimum baseline is determined. The task allocator 616 may additionally determine a second minimum baseline from the submitted baselines and store it as the expected baseline for completion of the special task. The second minimum baseline may have a value relatively greater than a value of the minimum baseline. If the employee completes the special task before the expected baseline, which is the assigned time limit, the remaining time may be converted to an additional incentive amount by the STIC module 618.

In one exemplary scenario, the task allocator 616 may receive a special task t′ with a budget B′ according to Equation 33A. The minimum submitted baseline for the task t′ may be denoted as θ^{(Min)} and the second minimum baseline may be denoted as θ^{(2ndMin)}.

B′=b+b′ (33A)

where:

B′=Organizational incentive budget for a particular special task

b=target budget in accordance with the minimum baseline, θ^{(Min)}

b′=target budget in accordance with the second minimum baseline, θ^{(2ndMin)}

The task allocator 616 may compute the second minimum baseline by considering all the received distinct baseline values from the employees. If the same value of the minimum baseline is received from multiple employees, the task allocator 616 may be configured to select an employee who has the highest trust measure for the task. Further, in case multiple employees have the same trust measure, the task allocator 616 may be configured to randomly select an employee from the set of employees who have the same but highest trust measure. The task allocator 616 may communicate the minimum baseline, the second minimum baseline (i.e., the expected baseline), and the received budget B′ to the STIC module 618, which may also receive the trust measure of the selected employee from the trust analyzer 614. In some embodiments, the STIC module 618 may receive the trust measure of the selected employee from the task allocator 616 or the database 608.

At 808, a task incentive for the special task is computed. In one embodiment, the STIC module 618 may be configured to compute the incentive amount [symbol] ⁽³⁾(eᵢ, t′) for the special task using the Equation 33B based on the data received from the task allocator 616 and/or the trust analyzer 614 and Equation 32.

[symbol]

⁽³⁾(eᵢ,t′)=b*Γᵢ+b′*φᵢ (33B)

In equation 33B, φᵢ is a parameter that is measured as a function of the time actually taken by the employee to complete the special task, the baseline bid of the employee, and the expected baseline of the task. Consequently, if an employee takes time θ (i.e., actual duration) to actually complete the special task, then the STIC module 618 may compute φᵢ based on Equation 34.

$${φ}_{i} = \{ \begin{matrix}1 , & if ϑ \leq {ϑ}^{( Mi n )} \\ 0 , & ϑ > {ϑ}^{( 2 ndMin )} \\ \frac{{ϑ}^{( 2 ndMin )} - ϑ}{{ϑ}^{( 2 ndMin )} - {ϑ}^{( Mi n )}} , & Otherwise\end{matrix} \qquad ( 34 )$$

Further, the STIC module 618 may be configured to compute the maximum incentive for a truthful baseline bid submitted by an employee based on his private belief. Let the baseline submitted by an employee be denote by θⁱ, his private belief be denoted by, (i.e., time duration submitted as baseline in a bid), the baselines submitted by other employees be denoted by θ₋ᵢ, and the minimum baseline (i.e., θ^{(Min)}) submitted by one of these other employees be equivalent to min_{j≠i}θⱼ. In one example, the baseline θ₋ᵢ may be a vector θ of all the baselines submitted for a special task, but with the baseline of the i^{th} employee being deleted.

If θᵢ>θ^{(Min)}, then the task allocator 616 may be configured not to assign the special task to the employee eᵢ and therefore, the employee does not receive any incentive, i.e. [symbol] ⁽³⁾(eᵢ, t′)=0. Consequently, the employee eᵢ may spend his time on the regular routine tasks. On the other hand, the task allocator 616 may assign the special task to the employee eᵢ if θᵢ<θ^{(Min)} and therefore, the employee eᵢ receives the incentive amount as shown in Equation 33B. As a result, if an employee submits his baseline bid truthfully (i.e., φᵢ=1), then the employee eᵢ may receive the maximum incentive [symbol] ⁽³⁾(eᵢ, t′) based on equation 33B.

Moreover, the STIC module 618 guarantees that every truthful employee eᵢ receives a non-negative incentive amount. In other words, the STIC module 618 ensures that a truthful employee receives an incentive amount that is greater than that for a set of routine tasks, i.e., [symbol] ⁽¹⁾(eᵢ) and [symbol] ⁽²⁾(eᵢ). This is achieved when the employee completes a special task within the expected baseline, i.e., the second minimum baseline. Accordingly, the STIC module 618 computes the incentive amount based on equation 33B, which is then going to be non-zero.

Additionally, if the employee bids truthfully, the STIC module 618 may be configured to minimize the task completion time defined in Equation 35.

Special Task Completion Time(STCT)=Σᵢ₌₁^{s}θᵢ*xᵢ (35)

where:

s=number of employees submitting their respective baselines for a particular special task

xᵢ=parameter whose value for an employee depends on whether or not the special task has been assigned

θᵢ=Employee's private belief for task completion and may be equivalent to an actual baseline submitted as a bid by the employee

In equation 35, the value of xᵢ=1 for an employee to whom the special task has been assigned, otherwise xᵢ=0. Hence, for an employee who has submitted the baseline bid truthfully, the special task completion time is shown in Equation 36. However, if an employee fails to perform the task by the expected baseline, he may receive relatively less incentive amount that the amount he could have possible earn by only limiting his invested time to work on the set of routine tasks. Accordingly, the STIC module 618 penalizes underperforming employees when the preset or their submitted baselines for the special tasks are not met.

(STCT)_{for e}_{_{i=Σ}}ᵢ₌₁^{s}θᵢ, since Σᵢ₌₁^{s}xᵢ=1 (36)

Based on equation 36, the STIC module 618 provides a strong performance guarantee as the employee performs based on his belief of completing the task within his submitted baseline. Further, the STIC module 618 communicates the computed incentive amount of equation 33B to the total incentive module 620.

The total incentive module 620 may be configured to receive the computed incentive amounts from the RTIC module 612 based on equations 24 and 27, and from the STIC module 618 based on equation 33B to compute a unified incentive amount for an employee eᵢ as shown in Equation 37.

[symbol]

(eᵢ)= [symbol] ⁽¹⁾(eᵢ)+ [symbol] ⁽²⁾(eᵢ)+Σⱼ₌₀^{l} [symbol] ⁽³⁾(eᵢ,tⱼ) (37)

where:

l=number of special tasks that the employee eᵢ could finish in a month M

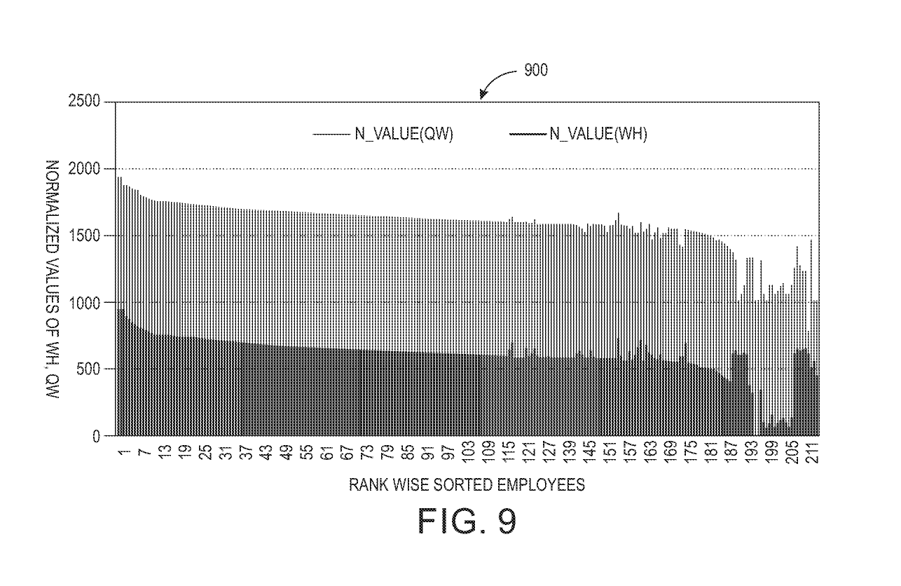

In one example, the unified incentive device 102 may determine the unified incentive amount for a dataset collected from a business process outsourcing (BPO) services organization. The dataset contains 214 employee records in terms of their target incentive, and the values of two KPIs, namely, the work duration, WD, (measured in minutes) and quality of work, QW (measured in percentage values). FIG. 9 is a graph 900 that illustrates normalized KPI values of the rank-wise sorted employees for one month. The total incentive module 620 was employed to compute the incentive amounts based on equation 37 for the dataset and compare it with a conventional incentive scheme.

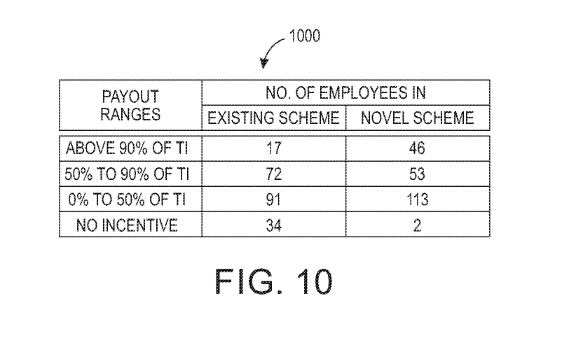

FIG. 10 is a table 1000 that illustrates a comparative study between the existing scheme and the novel incentive computation scheme implemented by the unified incentive device 102. As shown in the table 1000, in the existing or conventional scheme, the payout (i.e., a ratio of incentive disbursed to the total budget) was 47.9%, whereas in the novel scheme the payout is 56% (subject to change depending on the lower and upper limit of the KPI values) of the same total budget. In the novel scheme, vis-à-vis the existing scheme, the incentive amount increases for 73.83% of the population, decreases for 25.23% and remains same for 0.94%.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating” or “monitoring” or “displaying” or “tracking” or “identifying” “or receiving” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A computer implemented method for design and implementation of an employee incentive scheme for one or more tasks, the method comprising:
receiving, using a data input module on a computer with a processor and a memory, a task for a plurality of employees from a user device;
identifying, using the data input module, whether or not the task is associated with a predetermined baseline being related to an estimated time required to complete the task, wherein the task being identified as a routine task if associated with the predetermined baseline, else the task being identified as a special task; and
computing, using a unified incentive module on the computer, a task incentive for at least one of the routine task and the special task associated with an employee among the plurality of employees.

2. The computer implemented method according to claim 1, further comprising:
if the task is identified as the routine task by the data input module:
successively combining, using a routine task incentive computation (RTIC) module on the computer in communication with the unified incentive module, a predefined set of disparate key performance indicators (KPIs) associated with the routine task into a plurality of predefined categories to provide a unique set of KPIs, wherein a combined set of KPIs in at least one category has a causal relationship with another combined set of KPIs in another category in the plurality of predefined categories; and
computing, using the RTIC module, the task incentive for the employee based on the unique set of KPIs.

3. The computer implemented method according to claim 2, wherein the plurality of predefined categories includes combinable KPI, outcome-influencing KPI, and unrelated KPI.

4. The computer implemented method according to claim 3, wherein a disparate KPI in the predefined set being categorized as the outcome-influencing KPI has an absolute value capable of reducing the effect of another disparate KPI on the computed task incentive.

5. The computer implemented method according to claim 2, further comprising computing, using the RTIC module, an additional task incentive for high performance based on a value of each KPI in the unique set of KPIs being above a corresponding predefined KPI threshold value.

6. The computer implemented method according to claim 5, wherein the additional incentive is computed based on an employee score and a predefined organizational budget for the high performance, wherein the employee score is based on a performance parameter and a predefined priority of each KPI in the unique set of KPIs.

7. The computer implemented method according to claim 6, wherein the task incentive is computed based on the performance parameter and a sub-target incentive of the employee, wherein the sub-target incentive is related to each KPI in the unique set of KPIs.

8. The computer implemented method according to claim 7, wherein the performance parameter is a function of one or more KPIs categorized as an outcome-influencing KPI in the predefined set of disparate KPIs and an average deviation of the outcome-influencing KPIs.

9. The computer implemented method according to claim 1, further comprising:
if the task is identified as the special task by the data input module:
receiving, using the data input module, a bid of baseline for the special task from the employee based on a trust value of the employee being above a predefined trust threshold value;
selecting, using a task allocator on the computer, the employee for being assigned the special task among the plurality of employees provided the bid is a lowest bid corresponding to a minimum baseline among a plurality of bids received from the plurality of employees, wherein the employee has a predefined first target incentive;
determining, using a special task incentive computation (STIC) module on the computer in communication with the unified incentive module, a second lowest bid corresponding to a second minimum baseline among the plurality of bids, wherein the second minimum baseline is associated with another employee having a predefined second target incentive from the plurality of employees; and
computing, using the STIC module, the task incentive based on the trust value, the first target incentive, the second target incentive, the minimum baseline, the second minimum baseline, and an actual time taken by the selected employee to complete the special task.

10. The computer implemented method according to claim 9, wherein the trust value is computed by a trust analyzer on the computer based on a performance history of the employee, wherein the performance history is based on a ratio of baseline violations and a central tendency of baseline violation associated with the employee, wherein the central tendency is a function of an average percentage baseline violation and a standard deviation of a percentage baseline violation.

11. The computer implemented method according to claim 10, further comprising:
receiving, using the data input module, at least one bid equivalent to the minimum baseline among the plurality of bids, wherein the at least one bid is associated with a new employee among the plurality of employees; and
selecting, using the task allocator, one of the employees and the new employee based on a respective trust value being the highest.

12. A system for design and implementation of an employee incentive scheme for one or more tasks, the system being in communication with a user device, the system comprising:
a data input module on a computer with a processor and a memory being configured to:
receive a task for a plurality of employees from the user device; and
identify whether or not the task is associated with a predetermined baseline being related to an estimated time required to complete the task, wherein the task being identified as a routine task if associated with the predetermined baseline, else the task being identified as a special task; and
a unified incentive module on the computer configured to compute a task incentive for at least one of the routine task and the special task associated with an employee among the plurality of employees.

13. The system according to claim 12, wherein if the task is identified as the routine task by the data input module, the system further comprises:
a routine task incentive computation (RTIC) module on the computer in communication with the unified incentive module, wherein the RTIC module is configured to:
successively combine a predefined set of disparate key performance indicators (KPIs) associated with the routine task into a plurality of predefined categories to provide a unique set of KPIs, wherein a combined set of KPIs in at least one category has a causal relationship with another combined set of KPIs in another category in the plurality of predefined categories; and
compute the task incentive for the employee based on the unique set of KPIs.

14. The system according to claim 13, wherein the plurality of predefined categories includes combinable KPI, outcome-influencing KPI, and unrelated KPI.

15. The system according to claim 14, wherein a disparate KPI in the predefined set being categorized as the outcome-influencing KPI has an absolute value capable of reducing the effect of another disparate KPI on the computed task incentive.

16. The system according to claim 13, wherein an additional task incentive is being computed by the RTIC module for high performance based on a value of each KPI in the unique set of KPIs being above a corresponding predefined KPI threshold value.

17. The system according to claim 16, wherein the additional incentive is computed based on an employee score and a predefined organizational budget for the high performance, wherein the employee score is based on a performance parameter and a predefined priority of each KPI in the unique set of KPIs.

18. The system according to claim 17, wherein the task incentive is computed based on the performance parameter and a sub-target incentive of the employee, wherein the sub-target incentive is related to each KPI in the unique set of KPIs.

19. The system according to claim 18, wherein the performance parameter is a function of one or more KPIs categorized as an outcome-influencing KPI in the predefined set of disparate KPIs and an average deviation of the outcome-influencing KPIs.

20. The system according to claim 12, wherein if the task is identified as the special task, the data input module is further configured to receive a bid of baseline for the special task from the employee based on a trust value of the employee being above a predefined trust threshold value, wherein the system further comprises:
a task allocator on the computer configured to select the employee for the special task among the plurality of employees provided the bid is a lowest bid corresponding to a minimum baseline among a plurality of bids received from the plurality of employees, wherein the employee has a predefined first target incentive; and
a special task incentive computation (STIC) module on the computer in communication with the unified incentive module, wherein the STIC module is configured to:
determine a second lowest bid corresponding to a second minimum baseline among the plurality of bids, wherein the second minimum baseline is associated with another employee having a predefined second target incentive from the plurality of employees; and
compute the task incentive based on the trust value, the first target incentive, the second target incentive, the minimum baseline, the second minimum baseline, and an actual time taken by the selected employee to complete the special task.

21. The system according to claim 20, wherein the system further comprises:
a trust analyzer on the computer configured to compute the trust value based on a performance history of the employee, wherein the performance history is based on a ratio of baseline violations and a central tendency of baseline violation associated with the employee, wherein the central tendency is a function of an average percentage baseline violation and a standard deviation of a percentage baseline violation.

22. The system according to claim 20, wherein the data input module is further configured to receive at least one bid equivalent to the minimum baseline among the plurality of bids, wherein the at least one bid is associated with a new employee among the plurality of employees; and
the task allocator is further configured to select one of the employee and the new employee based on a respective trust value being the highest.

23. A non-transitory computer-readable medium comprising computer-executable instructions for design and implementation of an employee incentive scheme for one or more tasks, the non-transitory computer-readable medium comprising instructions for:
receiving a task for a plurality of employees from a user device;
identifying whether or not the task is associated with a predetermined baseline being related to an estimated time required to complete the task, wherein the task being identified as a routine task if associated with the predetermined baseline, else the task being identified as a special task; and
computing a task incentive for at least one of the routine task and the special task associated with an employee among the plurality of employees.

24. The claim according to claim 23, further comprising:
if the task is identified as the routine task:
successively combining a predefined set of disparate key performance indicators (KPIs) associated with the routine task into a plurality of predefined categories to provide a unique set of KPIs, wherein a combined set of KPIs in at least one category has a causal relationship with another combined set of KPIs in another category in the plurality of predefined categories; and
computing the task incentive for the employee based on the unique set of KPIs.

25. The claim according to claim 24, wherein the plurality of predefined categories includes combinable KPI, outcome-influencing KPI, and unrelated KPI.

26. The claim according to claim 25, wherein a disparate KPI in the predefined set being categorized as the outcome-influencing KPI has an absolute value capable of reducing the effect of another disparate KPI on the computed task incentive.

27. The claim according to claim 24, further comprising computing an additional task incentive for high performance based on a value of each KPI in the unique set of KPIs being above a corresponding predefined KPI threshold value.

28. The claim according to claim 27, wherein the additional incentive is computed based on an employee score and a predefined organizational budget for the high performance, wherein the employee score is based on a performance parameter and a predefined priority of each KPI in the unique set of KPIs.

29. The claim according to claim 28, wherein the task incentive is computed based on the performance parameter and a sub-target incentive of the employee, wherein the sub-target incentive is related to each KPI in the unique set of KPIs.

30. The claim according to claim 29, wherein the performance parameter is a function of one or more KPIs categorized as an outcome-influencing KPI in the predefined set of disparate KPIs and an average deviation of the outcome-influencing KPIs.

31. The claim according to claim 23, further comprising:
if the task is identified as the special task:
receiving a bid of baseline for the special task from the employee based on a trust value of the employee being above a predefined trust threshold value;
selecting the employee for the special task among the plurality of employees provided the bid is a lowest bid corresponding to a minimum baseline among a plurality of bids received from the plurality of employees, wherein the employee has a predefined first target incentive;
determining a second lowest bid corresponding to a second minimum baseline among the plurality of bids, wherein the second minimum baseline is associated with another employee having a predefined second target incentive from the plurality of employees; and
computing the task incentive based on the trust value, the first target incentive, the second target incentive, the minimum baseline, the second minimum baseline, and an actual time taken by the selected employee to complete the special task.

32. The claim according to claim 31, wherein the trust value is computed by a trust analyzer on the computer based on a performance history of the employee, wherein the performance history is based on a ratio of baseline violations and a central tendency of baseline violation associated with the employee, wherein the central tendency is a function of an average percentage baseline violation and a standard deviation of a percentage baseline violation.

33. The claim according to claim 31, further comprising:
receiving at least one bid equivalent to the minimum baseline among the plurality of bids, wherein the at least one bid is associated with a new employee among the plurality of employees; and
selecting one of the employee and the new employee based on a respective trust value being the highest.
